(19) United States
(12) Patent Application Publication
(10) Pub. No.: US 2007/0165370 A1
(43) Pub. Date: Jul. 19, 2007

(54) Portable computer with multiple monitors

(76) Inventor: Yao-Shih Leng, (US)

Correspondence Address: G. LINK CO. LTD., 3550 BELL ROAD, MINOOKA, IL, 60447, US

(21) Appl. No.: 11/331,157

(22) Filed: Jan. 13, 2006

(51) Int. Cl. G06F 1/16

(52) U.S. Cl. 361/683

(57) ABSTRACT

The present invention provides a portable computer with multiple monitors, comprising: a main unit; a first monitor pivotally disposed on one side of the main unit to display a first image signal; and at least one second monitor sited on the surface of the main unit to display a second image signal, wherein the second monitor provides a resolution of at least 160×160 pixels.

### FIELD OF THE INVENTION

The present invention relates to a portable computer, more particularly, to a portable computer with multiple monitors.

### BACKGROUND OF THE INVENTION

FIG. 1 illustrates a conventional computer system with multiple monitors. So far, commercial available portable computer 1 has only one monitor 10. In the Windows operating system environment, the contents A1, A2 and A3 of multiple files A1′, A2′ and A3′ on the tool bar 12 are shown layer-by-layer on the monitor 10 such that users must switch between the screens back and forth when working on those files at the same time, or close one screen and open another, which apparently adds to the hassle of running more than one file at a time.

To address the aforesaid drawback, prior art connects the portable computer 1 with an external monitor 14. As such, content A4 of an electronic file A4′ on the tool bar 12 can be displayed on the external monitor 14. However, such arrangement is still inconvenient for users because of the increase of hardware cost and the lack of portability.

### SUMMARY OF THE INVENTION

The primary object of the present invention is to provide a portable computer with multiple monitors that allows users to execute multiple tasks at the same time and reduces unnecessary switches between files.

Another object of the present invention is to provide a portable computer with multiple monitors that saves the cost of hardware and offers portability.

In accordance with the aforesaid objects, the present invention discloses a portable computer with multiple monitors, comprising: a main unit; a first monitor pivotally disposed on one side of the main unit to display a first image signal; and at least one second monitor sited on the surface of the main unit to display a second image signal, wherein the second monitor provides a resolution of at least 160×160 pixels.

The objects, features and advantages of the invention are described in details below with embodiments and accompanying drawings.

### BRIEF DESCRIPTION OF THE DRAWINGS

These and other modifications and advantages will become even more apparent form the following detained description of a preferred embodiment of the invention and from the drawings in which:

FIG. 1 illustrates a conventional computer system with multiple monitors;

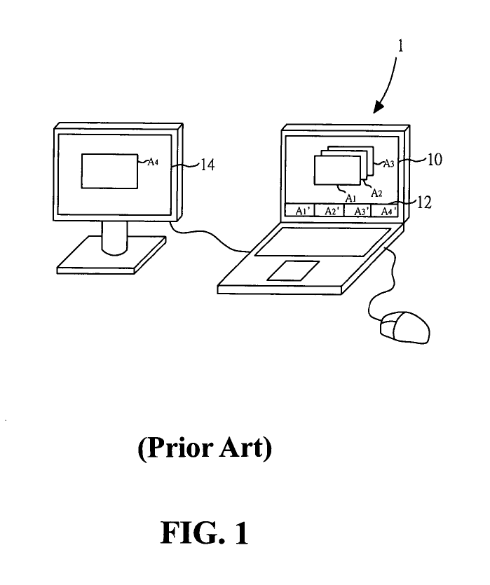

FIG. 2 illustrates the stereogram of an embodiment of the invention;

FIG. 3A illustrates a circuit diagram of the portable computer in FIG. 2;

FIG. 3B illustrates a second image signal displayed by the second monitor shown in FIG. 2;

FIG. 3C illustrates a first image signal displayed by the first monitor shown in FIG. 2;

FIG. 4 illustrates another circuit diagram of the portable computer shown in FIG. 2

### DETAILED DESCRIPTION OF THE INVENTION

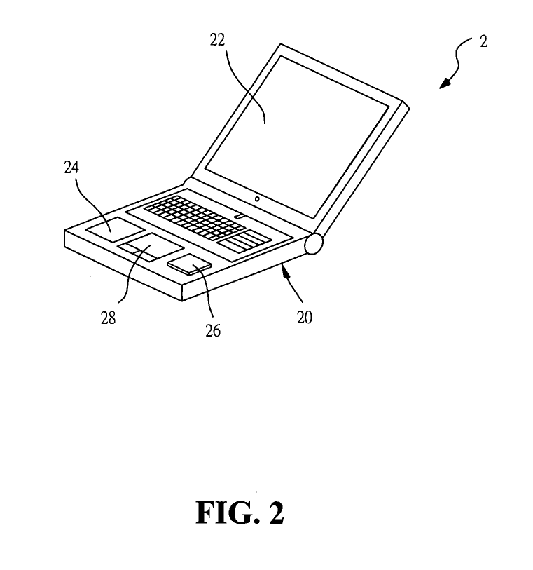

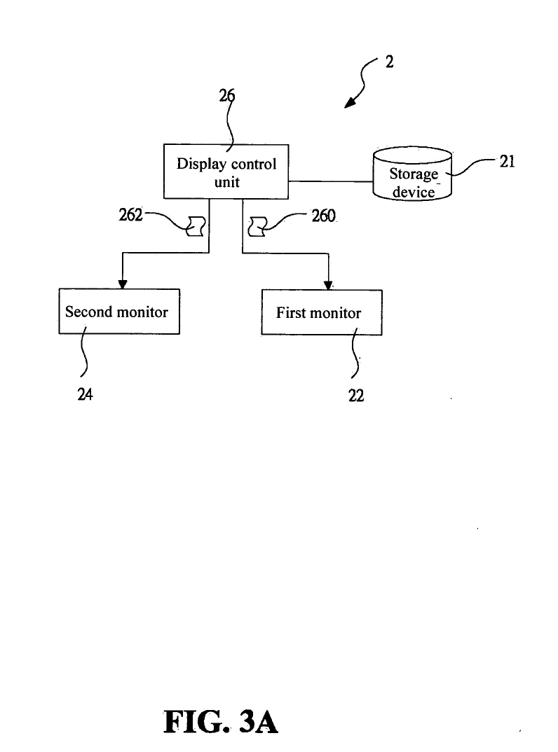

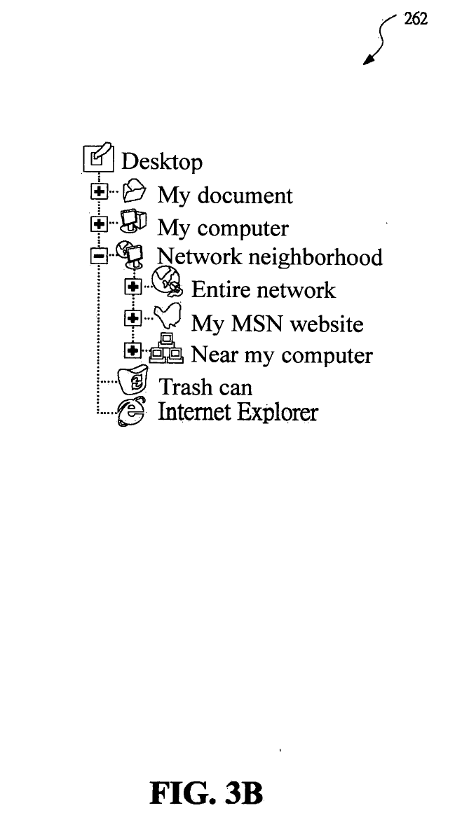

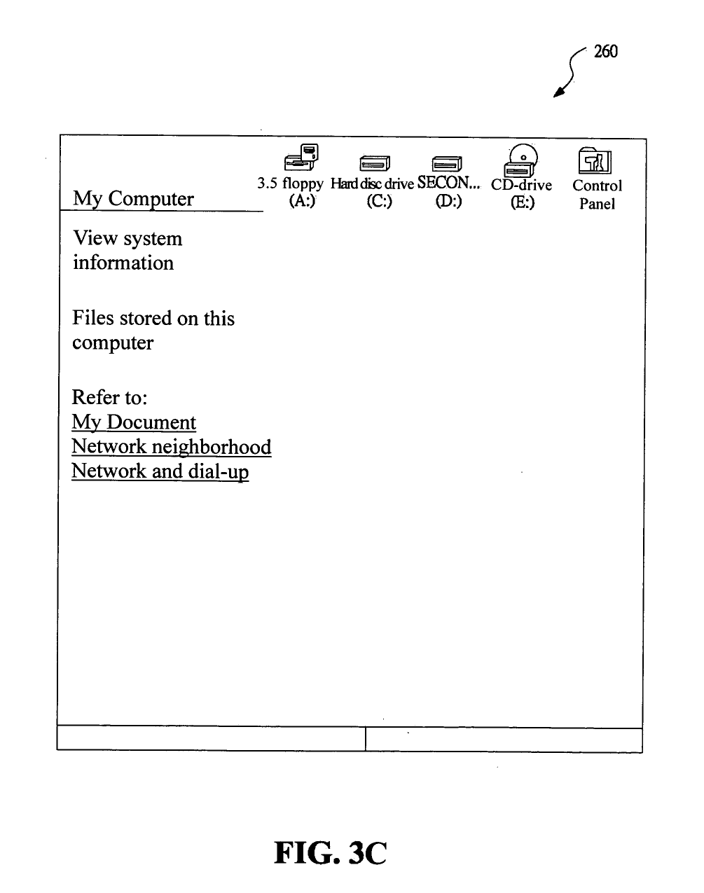

FIG. 2 illustrates an stereogram of an embodiment of the invention. FIG. 3A illustrates a circuit diagram of the portable computer shown in FIG. 2. As shown in FIG. 2, the portable computer 2 with multiple monitors of the present invention comprises: a main unit 20, a first monitor 22, and a second monitor 24, wherein the first monitor 22 is pivotally disposed on one side of the main unit 20 to display a first image signal 260; the second monitor 24 is sited on the surface of main unit 20, for example, next to a touch pad 28, to display a second image signal 262. The second monitor 24 provides a resolution of at least 160×160 pixels. The first monitor 22 and the second monitor 24 used in the invention are commonly liquid crystal displays.

As shown in FIG. 2 and FIG. 3A, the portable computer 2 herein further comprises a display control unit 26 electrically connected to the first monitor 22 and the second monitor 24 to output the first image signal 260 and drive the first monitor 22 to display the first image signal 260, and output the second image signal 262 and drive the second monitor 24 to display the second image signal 262. Furthermore, the portable computer 2 herein further comprises a storage device 21 to store at least one electronic file. As such, the present invention can display the corresponding icons and hierarchy of those electronic files through the second image signal 262 (as shown in FIG. 3B) so as to achieve the objective of file management. In addition, the first image signal 260 is used to display the corresponding contents of those electronic files. In the example of FIG. 3B, the first image signal 260 displays the content of an electronic file in the Windows operating system named “My computer” (FIG. 3C).

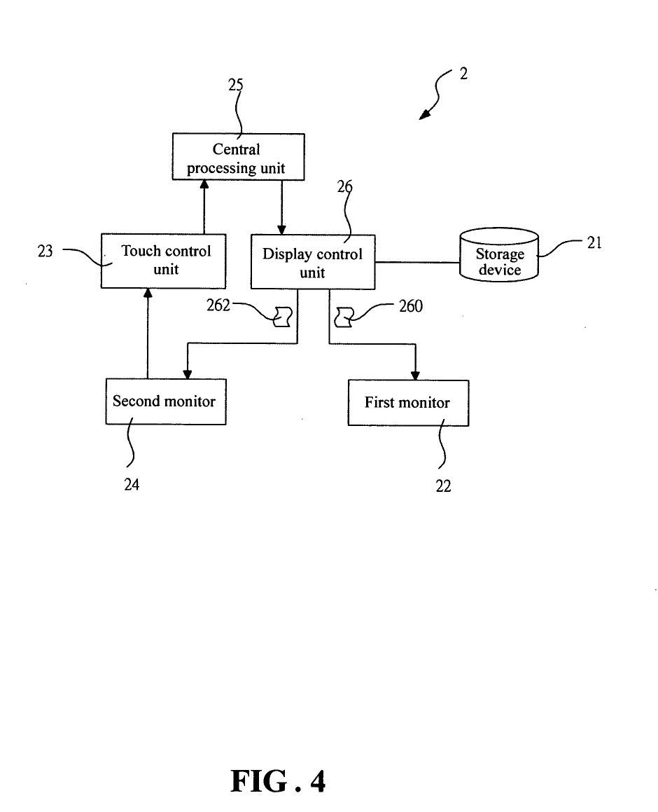

FIG. 4 is another circuit diagram of the portable computer in FIG. 2. As shown, the portable computer with multiple monitors 2 according to the invention further comprises a touch control unit 23 and a central processing unit 25 in addition to the display control unit 26 and the storage device 21. The touch control unit 23 is electrically connected to the second monitor 24 and the central processing unit 25, and the central processing unit 25 is electrically connected to the display control unit 26. When a user clicks on the icon displayed on the second monitor 24, the touch control unit 23 would notify the central processing unit 25 to execute the corresponding file of the icon, and the central processing unit 25 would drive the display control unit 26 to output the corresponding file content to the first monitor 22. Thus the second monitor 24 of the invention can be a touch pad. In the example of FIG. 3B, when a user clicks an icon of “My computer”, the touch control unit 23 would notify the central processing unit 25 to execute the corresponding file of the icon, and the central processing unit 25 would drive the display control unit 26 to output the file content to the first monitor 22 for display, as shown in FIG. 3C.

In addition, the second monitor 24 of the invention can possess the normal functions of a touch pad 28 (e.g. icon control), to enable the touch control panel of the second monitor 24 to possess a plurality of touch areas respectively corresponding to relative locations displayed on the first monitor 22 and can be used by the user to click and control said relative locations.

The features and functions of the present invention are summed up as following:

1. The portable computer according to the invention has multiple monitors and hence multi-task capability for users to execute several jobs at the same time. It is particularly suitable for the operation of computer game that when the game player is immersed in a game image displayed on the first monitor 22, the system can transmit concurrently a file, chat, or webpage message through the second monitor 24. The message transmission will not disrupt the ongoing game image or spoil the fun of player.

2. The second monitor 24 of the invention is directly provided on the surface of main unit 20, which costs less in terms of hardware than the prior art. Furthermore, the second monitor 24 provides a resolution of at least 160×160 pixels, which makes it easy for user to read without restricting the function of user interface due to resolution.

3. The second monitor 24 offers the user a function similar to the Windows “Commander” such that user only needs to click or select the file to be executed as shown by the file hierarchy structure displayed on second monitor 24, the content of the file will be opened on the first monitor 22. As such, the user can reduce the number of windows opened and cut down the unnecessary switching between files, thereby greatly enhancing the operational efficiency and the comfort of the user.

A few embodiments of the invention have been disclosed, which however should not be construed as a limitation on the scope of claim. All modifications and alterations to the descriptions disclosed made by those familiar with the skill without departing from the spirits of the invention and appended claims shall remain within the protected scope and claims of the invention.

What is claimed is:

1. A portable computer with multiple monitors, comprising:
a main unit;
a first monitor pivotally disposed on one side of the main unit to display a first image signal; and
at least one second monitor sited on the surface of main unit to display a second image signal, wherein the second monitor provides a resolution of at least 160×160 pixels.

2. The portable computer of claim 1, further comprising a display control unit electrically connected to the first monitor and the second monitor to output the first image signal and drive the first monitor to display the first image signal, and output the second image signal and drive the second monitor to display the second image signal.

3. The portable computer of claim 2, further comprising a storage device to store at least one electronic file.

4. The portable computer of claim 3, wherein said second image signal displays the corresponding icons of electronic files and the file hierarchy.

5. The portable computer of claim 4, wherein said first image signal displays the corresponding contents of electronic files.

6. The portable computer of claim 5, further comprising a touch control unit and a central processing unit, wherein the touch control unit is electrically connected to the second monitor and the central processing unit, and the central processing unit is electrically connected to the display control unit, such that when a user clicks an icon displayed on the second monitor, the touch control unit notifies the central processing unit to execute the corresponding file of icon, and the central processing unit drives the display control unit to output the corresponding content of the file to the first monitor for display.

7. The portable computer of claim 6, wherein the second monitor is a touch control panel.

8. The portable computer of claim 7, wherein the touch control panel has a plurality of touch areas that respectively correspond to relative locations displayed on the first monitor for user to click and control said relative locations.

9. The portable computer of claim 1, wherein the first monitor is a liquid crystal display.

10. The portable computer of claim 1, wherein the second monitor is a liquid crystal display.
